(19) United States
(12) Patent Application Publication
(10) Pub. No.: US 2006/0086265 A1
(43) Pub. Date: Apr. 27, 2006

(54) Pivotable citrus juicer

(75) Inventor: Fermin Miguel Santis Gonzalez, Cerrillos (CL)

Correspondence Address: D. PETER HOCHBERG CO. L.P.A., 1940 EAST 6TH STREET, CLEVELAND, OH, 44114, US

(73) Assignee: Virutex Ilko S.A.

(21) Appl. No.: 11/129,901

(22) Filed: May 16, 2005

(30) Foreign Application Priority Data
Jun. 29, 2004 (CL) 1656-04

(51) Int. Cl. B30B 7/00

(52) U.S. Cl. 100/234

(57) ABSTRACT

Pivotable, citrus juicer, press type, it has two arms having, at one of their ends, a spherical semi-cap to hold the fruit; the arm at the upper part is solid, backing-up, rounded outline, with a circular cross-section at the center part, and flat towards the outmost end from the pivot; at the lower part of the semi-sphere it has a rounded groove; next to the spherical zone there is a thicker, perforated rib, to install a shaft mating the lower part; the lower part of the assembly consists of a bent, thin-walled arm, attached to an empty, thin-walled semi-sphere, with symmetrical holes at the bottom; at the opposite end of the arm, it has two ribs thicker than the semi-sphere's wall, which are separated to allow the rib of the upper part of the assemble to fit, so that allowing the assembly to rotate.

### BACKGROUND OF THE INVENTION

1. Field of the Invention

The present invention relates generally to a manually operated fruit or citrus juicer, and more particularly to an ergonomic juicer which operates effectively and efficiently to obtain juice from fruit or citrus.

2. Description of Prior Art

Following the search of the state of the technology related to the juicer described herein, several types of juicers were found, namely: the domestic, Chilean applications 109-1973, 267-2000, 2988-2002, 1072-1996, and the foreign, non-Chilean applications GB2020964, dated Nov. 28, 1979, belonging to Philips N V, NL9301548 dated Apr. 3, 1995, belonging to Richard Johannes Van Der Heijd, and DE10128693 dated Dec. 19, 2002, belonging NEEB ELFRIEDE (DE), which is the most similar to the present invention.

### SUMMARY OF THE INVENTION

The present invention is a pivotal fruit or citrus juicer having two parts or arms to press the fruit for manually obtaining juice. Each part includes an arm which is connected to a semi-cup or fruit-holding part which is in turn connected to a piece which enables a pivot-like connection between the two parts.

An object of this invention is to provide a manually operated fruit or citrus juicer having a sleek and attractive appearance.

Another object of this invention is to provide a fruit or citrus juicer which is easy to operate.

Yet another object of this invention is to provide a fruit or citrus juicer which contains multiple holes through which the juice can be squeezed.

These and other objects will become apparent from the following description of a preferred embodiment taken together with the accompanying drawings.

### BRIEF DESCRIPTION OF THE DRAWINGS

The invention may take physical form in certain parts and arrangement of parts, a preferred embodiment of which will be described in detail in the specification and illustrated in the accompanying drawings which form a part hereof, and wherein:

FIG. 1 shows a fruit juicer assembly;

FIG. 2 shows an arm, and the upper part of the assembly shown in FIG. 1;

FIG. 3 shows a plan view of the upper part of the assembly shown in FIG. 2;

FIG. 4 shows an arm, and the lower part of the assembly shown in FIG. 1; and

FIG. 5 shows a plan view of the lower part of the assembly shown in FIG. 4.

### DETAILED DESCRIPTION OF THE PREFERRED EMBODIMENT

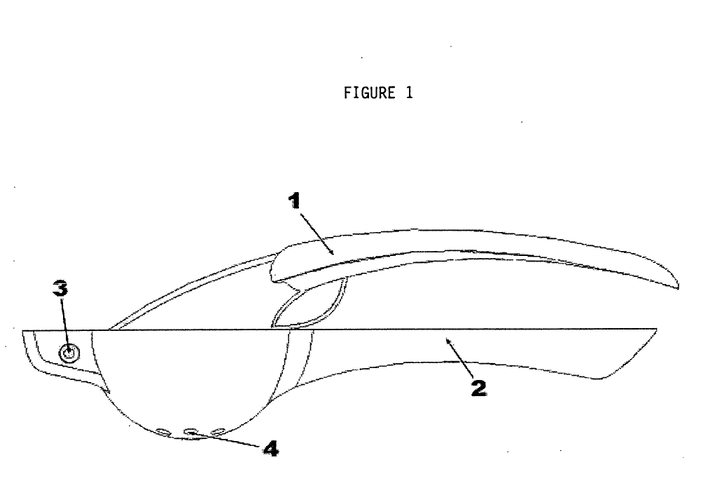

A pivotal fruit or citrus juicer, with an upper and a lower part each having an arm and a basket to enable manual pressing of fruit, is shown and described. FIG. 1 shows the juicer assembly, where 1 is the upper arm, 2 is the lower arm, 3 is the pivot in the rotation or pivotal hole, and 4 is the zone with holes to drain the juice.

The juicer apparatus has upper part 10 having a solid, generally rounded arm 1, with a semicircular cross-section at the middle, the arm becoming semi-elliptical towards its outmost or free end 12. On its opposing end, the arm engages an empty, thin-walled semi-hemispherically shaped semi-cup or convex, semi-spherical zone or press 5, which is attached to the arm through a wall thicker than the wall of the semi-cup. The semi-spherical convex press 5 is used to press the fruit from above. The exterior of the press has a small, rounded groove 7 for facilitating the juicing operation.

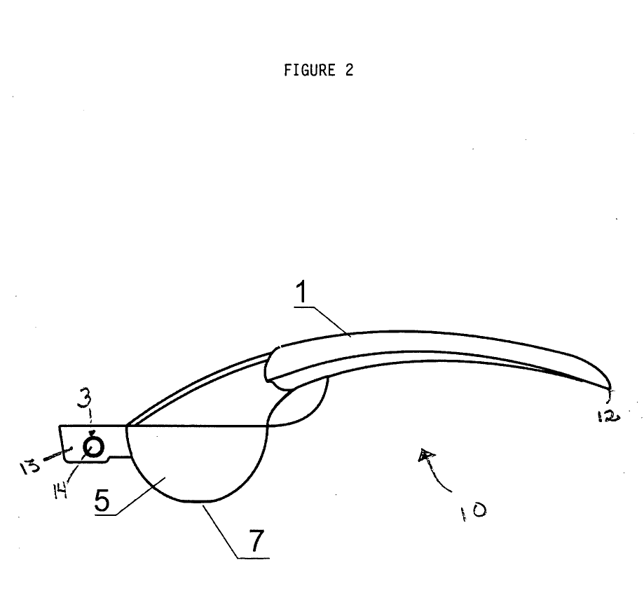

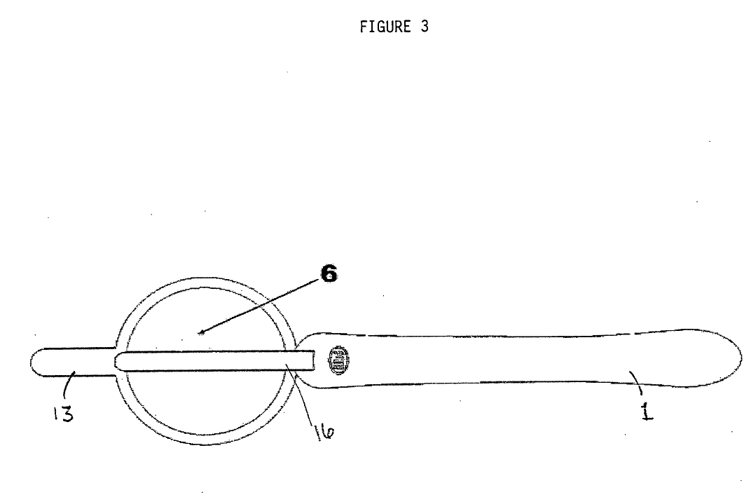

FIG. 2 shows the upper part and arm 1, its rotation or pivotal hole 3 and semi-spherical press 5 for pressing the fruit, and the rounded groove 7. FIG. 3 is a plan view of the upper part 10, where a thin-walled sphere 6 with a longitudinal, central wall 16 can be seen.

Next to the semi-spherical press 5, on the side to which the upper arm 1 is not attached, there is a shaft or lug 13 containing the rotation or pivotal hole 3 having an axle 14 for pivotally connecting the bottom or lower part 20 of the juicer to the upper part 10, as shown in FIG. 2.

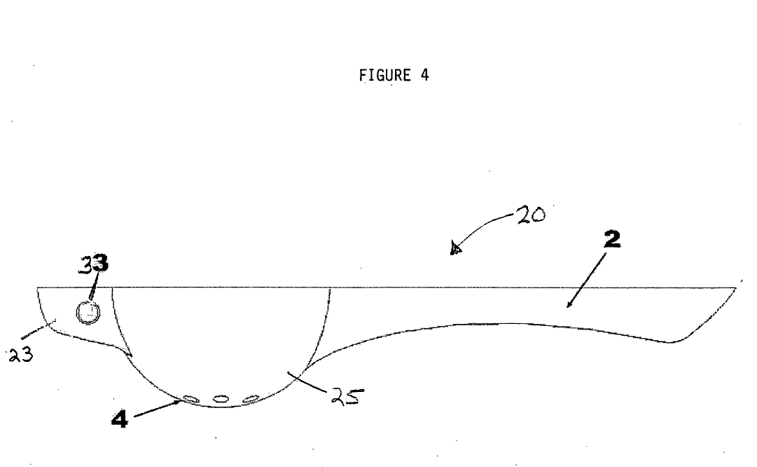

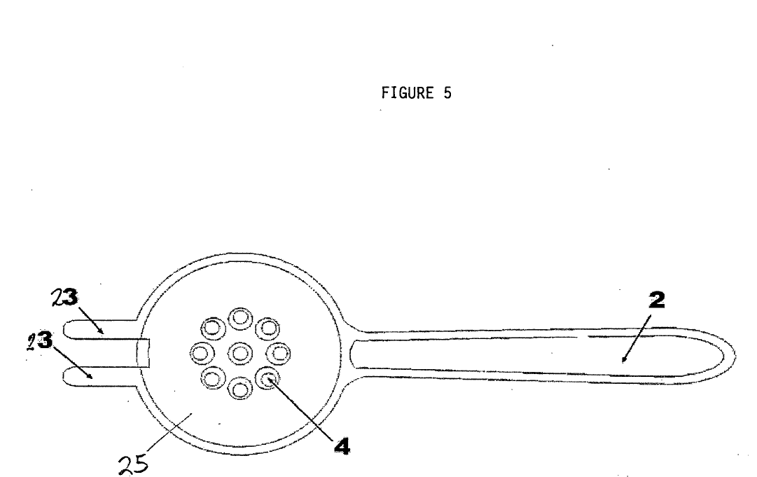

FIG. 4 shows the lower part 20 and its arm 2, one of a pair of perforated lower elements or flanges 23 being generally parallel and spaced apart, each having a rotation or aligned hole 33 which is aligned with the rotation hole of the other element, and mates with the rotation or pivotal hole 3 of the upper part 10, and a semi-spherical receptacle 25 with drain holes 4. FIG. 5 shows a plan view of the lower part 20 where 2 is the long, ergonomic, thin-walled arm, semi-spherical receptacle 25 includes holes 4 through which the juice is drained, and elements 23 are flanges which contain the aligned holes 33.

In a preferred embodiment, the upper part 10 includes the longitudinal central wall 16 for adding strength to the upper part 10. The arm 2 is solid, having a backing-up, rounded outline with a circular cross-section at the center portion and being flat towards the outermost end from the lug 14. The lower part 20 of the assembly consists of a bent, thin-walled arm 2, attached at one end to an empty, thin-walled semi-hemispherical receptacle 25, with nine holes 4 symmetrically located at its bottom. Beyond the receptacle 25, the arm has a pair of parallel, spaced flanges 23 thicker than the wall of the receptacle 25, the flanges both have aligned holes 33 and are separated to allow the lug 13 to fit therebetween, and axle 14 extends through the aligned holes 33, enabling the upper part 10 and the lower part 20 to rotate around the axle.

The invention has been described with particular emphasis on the preferred embodiments. It should be appreciated that these embodiments are described for purposes of illustration only, and that numerous alterations and modifications may be practiced by those skilled in the art without departing from the spirit and scope of the invention. It is intended that all such modifications and alterations be included insofar as they come within the scope of the invention or the equivalents thereof.

1. (canceled)

2. A fruit or citrus juicer, comprising:
an upper part including:
an upper arm having an attaching end and a free end;
a semi-spherical convex press attached to said attaching end of said upper arm; and
a lug extending from said press in a direction opposite to the direction of said arm, said lug having a pivotal hole transverse to the direction of said upper arm and said lug, said pivotal hole extending therethrough;
a lower part including:
a lower arm generally parallel to said upper arm and having an attaching end located generally at the location of the attaching end of said upper arm and a free end generally opposite to said free end of said upper arm;
a semi-spherical receptacle for receiving fruit, said receptacle being dimensioned for receiving said press to crush fruit in said receptacle, said receptacle having drain holes for draining juice therefrom; and
a pair of parallel, spaced flanges extending in a direction opposite the direction of said lower arm, for receiving said lug therebetween, said flanges having aligned holes for aligning with the pivotal hole in said lug when said lug is positioned between said flanges; and
an axle extending through the aligned holes of said lug and said flanges for enabling the pivoting of said upper arm and said lower arm to further enable said press to crush fruit in said receptacle to discharge juice from the fruit to flow through said drain holes.

3. A fruit or citrus juicer according to claim 2, wherein the number of holes for draining juice is nine.

4. A fruit or citrus juicer according to claim 2, wherein said semi-spherical press has a small rounded groove.

5. A fruit or citrus juicer according to claim 2, wherein said upper arm is ergonomic for ease of gripping, and said lower arm is ergonomic for ease of gripping.

6. A fruit or citrus juicer according to claim 2, wherein said press is thin-walled and further comprises a longitudinal, central wall for adding strength to the upper part.
